(19) United States
(12) Patent Application Publication
(10) Pub. No.: US 2013/0024702 A1
(43) Pub. Date: Jan. 24, 2013

(54) CONNECTING MODULE FOR COUPLING OUTPUT ENDS OF A HOST DEVICE TO AN EXTERNAL STORAGE DEVICE AND METHOD THEREOF

(71) Applicants: Chao-Feng Chueh, Taipei City (TW); Pei-Yu Huang, New Taipei City (TW); Li-Jen Chao, New Taipei City (TW)

(72) Inventors: Chao-Feng Chueh, Taipei City (TW); Pei-Yu Huang, New Taipei City (TW); Li-Jen Chao, New Taipei City (TW)

(21) Appl. No.: 13/186,485

(22) Filed: Jul. 20, 2011

(51) Int. Cl. G06F 1/26

(52) U.S. Cl. 713/300

(57) ABSTRACT

A connecting module includes a plurality of input ends and an output end. The output end of the connecting module is coupled to an external storage device. When at least two input ends of the connecting module are coupled to corresponding output ends of the host device, the connecting module outputs power supplied by the host device to the external storage device via the plurality of input ends. This way, the connecting module outputs power to the external device when at least two input ends of the connecting module are coupled to the host device, for ensuring the external storage device to receive sufficient power at the instant the external storage device receives power.

### BACKGROUND

1. Technical Field

The present invention is related to a connecting module, and more particularly, to a connecting module for coupling outputs of a host device to an external storage device.

2. Description of the Conventional Art

Conventional external storage devices, such as external hard drives, are generally powered through a universal serial bus (USB) port. For instance, a 2.5 inch hard drive requires at least 500 milliamps (mA) approximately to startup, and certain hard drives may require as high as more than 600-800 mA to startup. However, there is a limit of how much power a single USB port can supply. For instance, the limit of how much power a single USB port can provide is measured in “unit loads”, which are 100 mA for USB 2.0 and 150 mA for USB 3.0. When there are no other devices connected, a single port can provide at most 5 unit loads for USB 2.0 and 6 unit loads for USB 3.0. In other words, the maximum current a single USB 2.0 port can supply is approximately 500 mA, and the maximum current a single USB 3.0 port can supply is approximately 900 mA.

Therefore, when the external storage device is coupled to one single USB port, the power supplied by the USB port may not be sufficient to startup the external storage device. By supplying insufficient power to the external storage device is likely to cause damage to the hard drive. When the power supplied by the USB port approximately equals power required to startup the external storage device, the external storage device may be turned on and off frequently, due to the power supplied by the USB port fluctuates around the minimum threshold required to startup the external storage device. The external storage device is easily damaged when being turned off suddenly, or being turned on and off frequently.

The conventional solution is to utilize a Y cable to supply power to the external storage device from two USB ports. When utilizing the Y cable to couple the external storage device to the USB ports, a user usually plugs a first end of the Y cable into one USB port and then plugs a second end of the Y cable into another USB port. However, when the user has plugged the first end of the Y cable into one USB port before plugging the second end of the Y cable into another USB port, the external storage device is supplied with insufficient power and operated around the minimum threshold required to startup the external storage device, thus may damage the external storage device.

### SUMMARY

The present invention discloses a connecting module for coupling output ends of a host device to an external storage device. The connecting module comprises a first input end, a second input end, a power end, and an output end. The first input end is for coupling to a first output end of the host device. The second input end is for coupling to a second output end of the host device. The power end is for turning on the connecting module. The output end is for coupling to the external storage device. When the first input end and the second input end are coupled to the first output end and the second output end of the host device respectively, the output end outputs power provided by the host device to the external storage device.

The present invention further discloses an external storage module. The external storage module comprises a connecting module and an external storage device. The connecting module comprises an output end and a plurality of input ends for coupling to corresponding output ends of a host device. The external storage device is coupled to the output end of the connecting module. The external storage device comprises storage means, and the storage means receives power from the host device when at least two input ends of the plurality of input ends of the connecting module are coupled to the corresponding output ends of the host device.

The present invention further discloses a method for coupling output ends of a host device to an external storage device. The method comprises coupling at least one input end of a connecting module to at least one output end of the host device; coupling an output end of the connecting module to the external storage device; detecting whether a predetermined number of input ends of the connecting module are coupled to a corresponding number of output ends of the host device; and when the predetermined number of the input ends of the connecting module are coupled to the corresponding number of the output ends of the host device, outputting power provided by the host device to the external storage device via the connecting module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a connecting module according to a first embodiment of the present invention.

FIG. 2 is a diagram illustrating a connecting module according to a second embodiment of the present invention.

FIG. 3 is a diagram illustrating a connecting module according to a third embodiment of the present invention.

FIG. 4 is a diagram illustrating an external storage module according to a fourth embodiment of the present invention.

FIG. 5 is a diagram illustrating a connecting module according to a fifth embodiment of the present invention.

FIG. 6 is a diagram illustrating a method for coupling output ends of a host device to an external storage device according to a sixth embodiment of the present invention.

### DETAILED DESCRIPTION

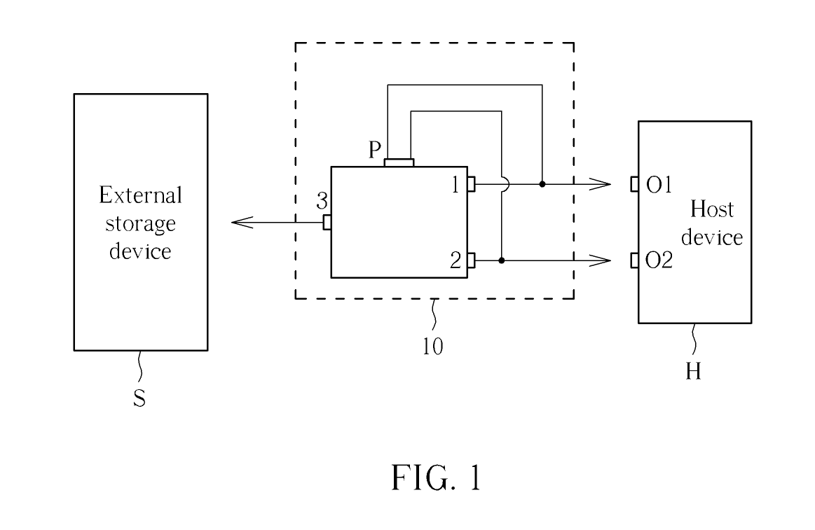

Please refer to FIG. 1. FIG. 1 is a diagram illustrating a connecting module 10 according to a first embodiment of the present invention. As illustrated in FIG. 1, the connecting module 10 comprises a first input end 1, a second input end 2, a power end P and an output end 3. The first input end 1 and the second input end 2 of the connecting module 10 are for coupling to a first output end O1 and a second output end O2 of a host device H respectively. The output end 3 of the connecting module 10 is for coupling to an external storage device S.

The power end P is coupled to the first input end 1 and the second input end 2 of the connecting module 10. The connecting module 10 is turned on when the power end P receives power from either the first input end 1 or the second input end 2. For instance, when the first input end 1 of the connecting module 10 is coupled to the first output end O1 of the host device H and/or when the second input end 2 of the connecting module 10 is coupled to the second output end O2 of the host device H, the power end P receives power from the first output end O1 and/or the second output end O2 of the host device H respectively and turns on the connecting module 10.

When the output end 3 of the connecting module 10 is coupled to the external storage device S, and only the first input end 1 or only the second input end 2 of the connecting module 10 is coupled to the first output end O1 or the second output end O2 of the host device H respectively, the connecting module 10 is turned on but the connecting module 10 does not output any power to the external storage device S via the output end 3.

When the output end 3 of the connecting module 10 is coupled to the external storage device S, and the first input end 1 and the second input end 2 of the connecting module 10 are both coupled to the first output end O1 and the second output end O2 of the host device H respectively, the output end 3 of the connecting module 10 outputs power supplied by the first output end O1 and the second output end O2 of the host device H to the external storage device S. In other words, the connecting module 10 outputs power from the host device H to the external storage device S when both input ends 1, 2 of the connecting module 10 are coupled to the corresponding output ends O1, O2 of the host device H.

Furthermore, the input end 1 of the connecting module 10 may receive both data and power from the first output end O1 of the host device H, and the input end 2 of the connecting module may merely receive power from the second output end O2 of the host device H. When the first input end 1 and the second input end 2 of the connecting module 10 are both coupled to the first output end O1 and the second output end O2 of the host device H respectively, the connecting module 10 outputs power supplied by both the first output end O1 and the second output end O2 of the host device H to the external storage device S, and outputs the data received merely from the first output end O1 to the external storage device S.

In the present embodiment, the connecting module 10 can comprise an AND gate. The host device H can comprise a desktop computer or a laptop. The first output end O1 of the host device H can be any interfaces capable of outputting data and power at the same time, such as a USB port, IEEE 1394 6-pin port, THUNDERBOLT™ port, external SATA (eSATA) port, DisplayPort, etc., and the second output end O2 of the host device H can be any interface capable of outputting power, such as a USB port, IEEE 1394 6-pin port, THUNDERBOLT™ port, Direct Current (DC) power port, etc . The output end 3 of the connecting module 10 is coupled to the external storage device S via an interface capable of outputting data and power at the same time, such as a USB port, IEEE 1394 6-pin port, THUNDERBOLT™ port, etc.

Since the connecting module 10 outputs power to the external storage device S when both the first input end 1 and the second input end 2 are coupled to the first output end O1 and the second output end O2 respectively, the external storage device S does not receive power from only the first output end O1 or the second output end O2, but both the first output end O1 and the second output end O2. This way, when the connecting module 10 outputs power to the external storage device S, the external storage device S is ensured to receive sufficient power to startup.

Please note that the above embodiment of the connecting module 10 is merely an exemplary illustration of the present invention, those skilled in the art can certainly make appropriate modifications according to practical demands, such as incorporating more than two input ends to the connecting module 10, which also belongs to the scope of the present invention. For instance, the connecting module 10 comprises three input ends, a power end P and an output end 3. The connecting module 10 outputs power to the external storage device S when at least two input ends of the three input ends of the connecting module 10 are coupled to the corresponding output ends of the host device H respectively.

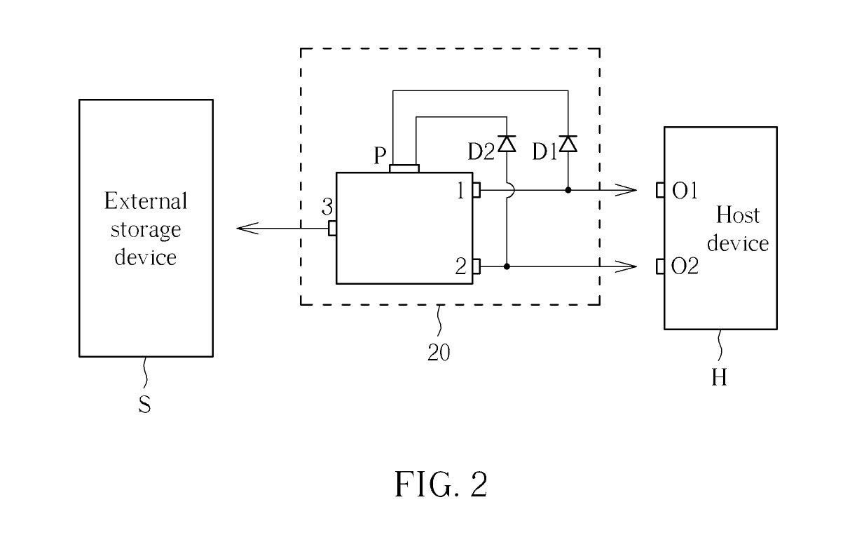

Please refer to FIG. 2. FIG. 2 is a diagram illustrating a connecting module 20 according to a second embodiment of the present invention. The connecting module 20 is similar to the connecting module 10 of the first embodiment shown in FIG. 1. The difference is that the connecting module 20 further comprises a first diode D1 and a second diode D2. The first diode D1 is coupled between the first input end 1 and the power end P of the connecting module 20. The second diode D2 is coupled between the second input end 2 and the power end P of the connecting module 20. More specifically, the cathode ends of the first and second diodes D1 and D2 are coupled to the power end P of the connecting module 20, and the anode ends of the first and second diodes D1 and D2 are coupled to the first and second input ends 1 and 2 of the connecting module 20 respectively. The first and second diodes D1 and D2 are disposed to prevent the first input end 1 and the second input end 2 of the connecting module 10 from being shorted to each other therefore making the connecting module 10 outputting power provided by the host device H to the external device S when only the first input end 1 or only the second input end 2 is coupled to the host device H.

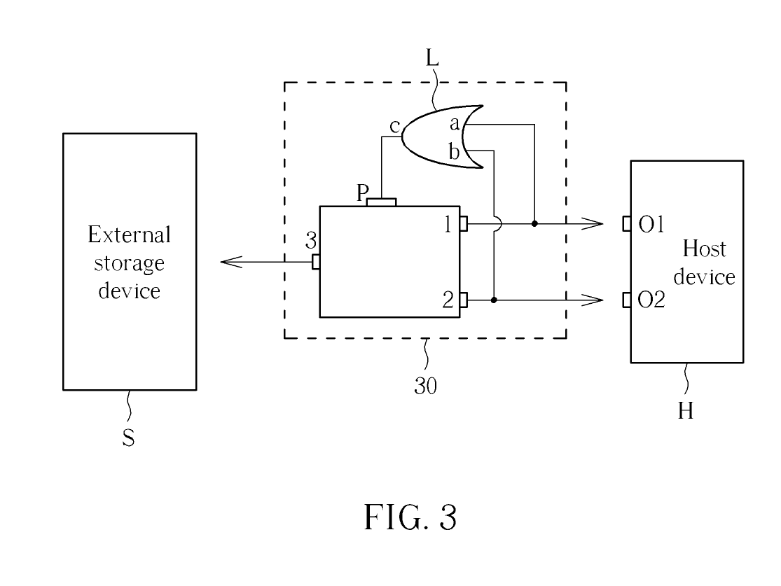

Please refer to FIG. 3. FIG. 3 is a diagram illustrating a connecting module 30 according to a third embodiment of the present invention. The connecting module 30 is similar to the connecting module 10 of the first embodiment shown FIG. 1. The difference is that the connecting module 30 further comprises a logic operator L. The logic operator L comprises a first input end a, a second input end b and an output end c. The first input end a of the logic operator L is coupled to the first input end 1 of the connecting module 30. The second input end b of the logic operator L is coupled to the second input end 2 of the connecting module 30. The output end c of the logic operator L is coupled to the power end P of the connecting module 30.

In the third embodiment, the logic operator L can be realized with an OR gate. When the first input end 1 of the connecting module 30 is coupled to the first output end O1 of the host device H, or when the second input end 2 of the connecting module 30 is coupled to the second output end O2 of the host device H, the output end c of the logic operator L outputs power to turn the connecting module 30 on accordingly. This way, the logic operator L prevents the first input end 1 and the second input end 2 of the connecting module 30 from being shorted to each other.

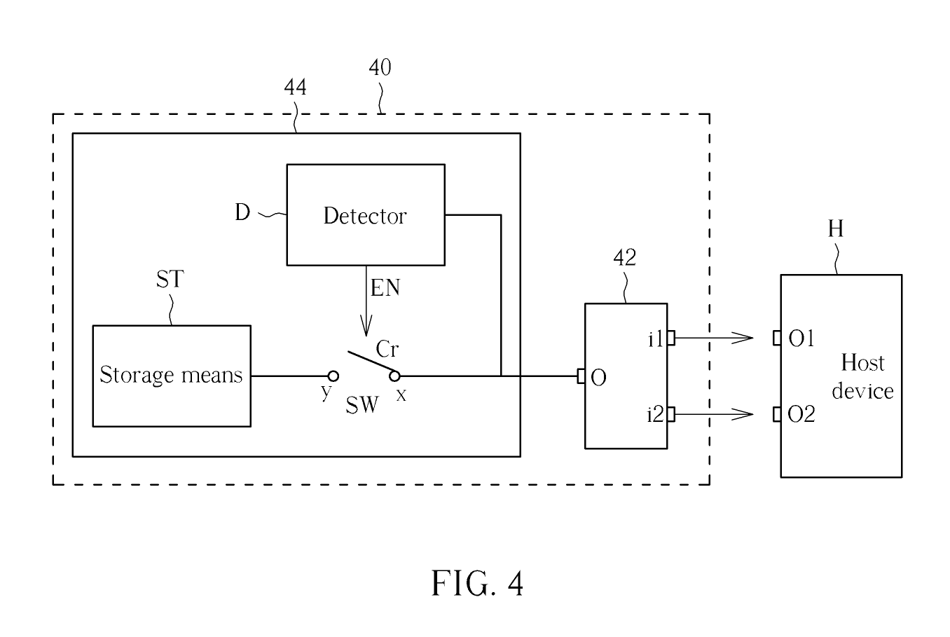

Please refer to FIG. 4. FIG. 4 is a diagram illustrating an external storage module according to a fourth embodiment of the present invention. The external storage module 40 comprises a connecting module 42 and an external storage device 44. The connecting module 42 comprises an output end O and a plurality of input ends for coupling to corresponding output ends of a host device H. In the present embodiment, the connecting module 42 comprises two input ends i1 and i2 for coupling to corresponding first output end O1 and second output end O2 of the host device H, but is not limited to this. The connecting module 42 may comprise at least two input ends, for coupling to corresponding output ends of the host device H respectively. The external storage device 44 is coupled to the output end O of the connecting module 42. The external storage device 44 comprises a detector D, a switch SW, and storage means ST. The storage means ST may comprise, but not limited to, a hard drive, an optical disc drive or a solid-state drive (SSD) etc.

The detector D comprises an input end and an output end. The input end of the detector D is coupled to the output end O of the connecting module 42. The detector D detects whether input ends i1 and i2 of the connecting module 42 are coupled to the corresponding output ends of the host device H. When the input ends i1 and i2 of the connecting module 42 are coupled to the corresponding output ends of the host device H, the detector D outputs an enabling signal EN from the output end of the detector D.

The switch SW comprises a first end x, a second end y, and a control end Cr. The first end x of the switch SW is coupled to the output end O of the connecting module 42. The second end y of the switch SW is coupled to the storage means ST of the external storage device 44. The control end Cr of the switch SW is coupled to the output end of the detector D for receiving the enabling signal EN. The switch SW is turned off (e.g. first end x and second end y are open) by default. When the control end Cr of the switch SW receives the enabling signal EN, the switched SW is turned on, such that the first end x of the switch SW is coupled to the second end y.

When input ends i1 and i2 of the connecting module 42 are coupled to the corresponding output ends of the host device H, the detector D outputs the enabling signal EN. The switch SW is then turned on according to the enabling signal EN, for the storage means ST to receive power from the input ends of the connecting module 42 that are coupled to corresponding output ends of the host device H. If only the input end i1 is coupled to the first output end O1, or only the input end i2 is coupled to the second output end O2, or neither of input ends i1 and i2 is coupled to the host device H, the detector D does not output the enabling signal EN. Hence the switch SW is turned off and the storage means ST does not receive any power from the host device H.

This way, the storage means ST of the external storage device 44 receives power from the host device H when the input ends i1 and i2 of the connecting module 42 are coupled to the corresponding output ends of the host device H. In other words, the storage means ST of the external storage device 44 is ensured to receive sufficient power at the instant the external storage device receives power.

In another embodiment of the present invention, if the connecting module 42 comprises more than two input ends, the detector D outputs the enabling signal EN when a predetermined number of input ends are coupled to the corresponding output ends of the host device H. The predetermined number of input ends required to couple to the host device H for the detector D to output the enabling signal EN may vary according to different types of storage means ST. That is, if the connecting module 42 comprises more than two input ends, the predetermined number of input ends required to couple to the host device H for the detector D to output the enabling signal EN comprises at least two input ends. For instance, assuming the connecting module 42 comprises three input ends, and if the storage means is a normal hard drive, the detector D can be configured to output the enabling signal EN when at least two out of the three input ends of the connecting module 42 are coupled to the corresponding output ends of the host device H; on the other hand if the storage means is a high-speed hard drive which requires more power to startup, then the detector D can be configured to output the enabling signal EN when all three input ends of the connecting module 42 are coupled to the corresponding output ends of the host device H.

In the present embodiment, the detector D can detect whether input ends of the connecting module 42 are coupled to the host device H according to whether current received from the output end O of the connecting module 42 has reached a predetermined threshold. Hence when at least two input ends of the connecting module 42 are coupled to the host device H, the detector D outputs the enabling signal EN. The switch SW is then turned on according to the enabling signal EN, for the storage means ST to receive power from the at least two input ends of the connecting module 42 coupled to the host device H.

In the present embodiment, the connecting module 42 can be realized with a Y cable compatible with one or more interfaces such as USB, IEEE 1394, THUNDERBOLT™, Direct Current (DC) power port, etc. The host device H can comprise a desktop computer or a laptop, and is similar to the host device H of the first embodiment shown FIG. 1.

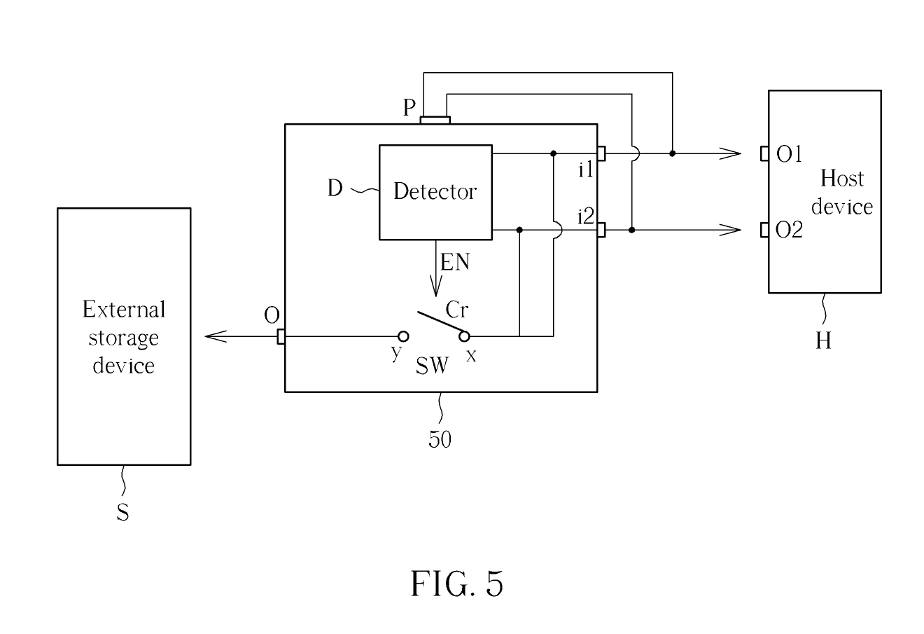

Please refer to FIG. 5. FIG. 5 is a diagram illustrating a connecting module 50 according to a fifth embodiment of the present invention. As illustrated in FIG. 5, the connecting module 50 comprises an output end O, a power end P, and a plurality of input ends, such as input ends i1 and i2 for coupling to corresponding first output ends O1 and O2 of the host device H respectively. The output end O of the connecting module 50 is for coupling to an external storage device S. The power end P is coupled to the input ends i1 and i2 of the connecting module 50. The connecting module 50 is turned on when the power end P receives power from either input ends i1 or i2.

The connecting module 50 further comprises a detector D and a switch SW. The detector D and the switch SW are also powered on when the power end P receives power from either input ends i1 or i2. The detector D comprises two input ends and an output end. The input ends of the detector D are coupled to the input ends i1 and i2 of the connecting module 50 respectively.

The detector D detects whether input ends i1 and i2 of the connecting module 50 are coupled to the corresponding output ends of the host device H. For instance, when input end i1 of the connecting module 50 is coupled to the output end O1 of the host device H, the input end of the detector D coupled to the input end i1 receives a signal of logic high, and the detector D then determines the input end i1 of the connecting module 50 is coupled to the host device H. When the detector D determines the input ends i1 and i2 of the connecting module 50 are both coupled to the corresponding output ends of the host device H, the detector D outputs an enabling signal EN from the output end of the detector D.

The switch SW comprises a first end x, a second end y, and a control end Cr. The first end x of the switch SW is coupled to the input ends i1 and i2 of the connecting module 50. The second end y of the switch SW is coupled to the output end O of the connecting module 50. The control end Cr of the switch SW is coupled to the output end of the detector D for receiving the enabling signal EN. The switch SW is turned off by default. When the control end Cr of the switch SW receives the enabling signal EN, the switched SW is turned on (e.g. first end x is coupled to the second end y), for outputting the power of the input ends i1 and i2 of the connecting module 50 received from the corresponding output ends O1 and O2 to the external storage device S via the output end O.

In other words, when the connecting module 50 outputs power from the host device H to the external storage device S, the power outputted is ensured to be sufficient to reliably turn the external storage device S on, since the connecting module 50 outputs power when input ends i1 and i2 of the connecting module 50 are coupled to corresponding output ends of the host device H.

In another embodiment, the connecting module 50 may comprise more than two input ends, and the detector D may comprise a corresponding number of input ends coupled to the input ends of the connecting module 50 respectively. Since the connecting module 50 comprise more than two input ends, it may not be necessary for all input ends of the connecting module 50 to be coupled to the host device H for ensuring the external storage device S to receive sufficient power. That is, the detector D of the connecting module 50 can output the enabling signal EN when a predetermined number of input ends of the plurality of input ends of the connecting module 50 are coupled to the corresponding output ends of the host device H. The predetermined number of input ends of the connecting module 50 required to be coupled to the host device H for ensuring the external storage device S to receive sufficient power comprises at least two input ends. For instance, assuming the connecting module 50 comprises three input ends, the detector D can be configured to output the enabling signal EN when at least two out of the three input ends of the connecting module 50 are coupled to the corresponding output ends of the host device H.

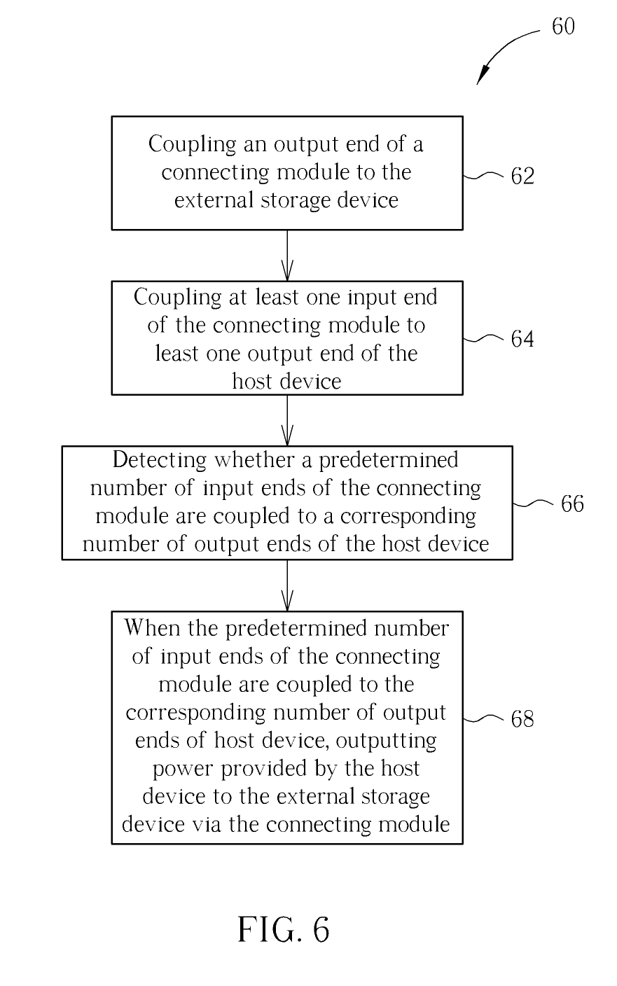

Please refer to FIG. 6. FIG. 6 is a diagram illustrating a method for coupling output ends of a host device to an external storage device according to a sixth embodiment of the present invention. Steps of the method 60 are further detailed below:

Step 62: coupling an output end of a connecting module to the external storage device;

Step 64: coupling at least one input end of the connecting module to at least one corresponding output end of the host device;

Step 66: detecting whether a predetermined number of input ends of the connecting module are coupled to the output ends of the host device; and

Step 68: when the predetermined number of input ends of the connecting module are coupled to the host device, outputting power provided by the host device to the external storage device via the connecting module.

Step 62 does not necessarily have to be performed before step 64. In another embodiment, step 64 may be performed before step 62. In yet another embodiment, steps 62 and 64 may be performed at the same time. In step 64, when at least one of the input ends of the connecting module is coupled to the host device, the connecting module is powered by the host device via the input end of the connecting module coupled to the host device. In step 68, when the predetermined number of input ends of the connecting module is coupled to the host device, the connecting module outputs power received from the input ends of the connecting module coupled to the host device to the external storage device, for the external storage device to startup. In step 66 and 68, the predetermined number of input ends of the connecting module comprises at least two input ends.

In summary, the present invention discloses a connecting module for coupling output ends of a host device to an external storage device. The connecting module comprises a plurality of input ends and an output end. The output end of the connecting module is coupled to the external storage device. The connecting module ensures the external storage device receives sufficient power. That is, when the connecting module comprise two input ends, the connecting module outputs power to the external device when all input ends of the connecting module are coupled to the host device, and when the connecting module comprise more than two input ends, the connecting module outputs power to the external device when at least two input ends of the connecting module are coupled to the host device. Therefore, when the user has not plugged at least two input ends of the connecting module to the host device, the connecting module does not output power to the external storage device, and prevents damaging the external storage device due to supplying insufficient power to the external storage device. This way, at the instant the external storage device receives power, the external storage device is ensured to receive sufficient power from all input ends of the connecting module to startup the external storage device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connecting module for coupling output ends of a host device to an external storage device, the connecting module comprising:
a first input end, for coupling to a first output end of the host device;
a second input end, for coupling to a second output end of the host device;
a power end, for turning on the connecting module; and
an output end, for coupling to the external storage device;
wherein when the first input end and the second input end are both coupled to the first output end and the second output end of the host device respectively, the output end outputs power provided by the host device to the external storage device.

2. The connecting module of claim 1, wherein the power end is coupled to the first input end and the second input end of the connecting module, when the first input end is coupled to the first output end of the host device and/or when the second input end is coupled to the second output end of the host device, the power end turns the connecting module on according to power of the first output end or the second output end of the host device.

3. The connecting module of claim 2, further comprising:
a first diode, coupled between the first input end and the power end; and
a second diode, coupled between the second input end and the power end.

4. The connecting module of claim 1, further comprising:
a logic operator, comprising:
a first input end, coupled to the first input end of the connecting module;
a second input end, coupled to the second input end of the connecting module; and
an output end, couple to the power end of the connecting module;
wherein when the first input end of the connecting module is coupled to the first output end of the host device and/or when the second input end of the connecting module is coupled to the second output end of the host device, the logic operator turns the connecting module on.

5. The connecting module of claim 1, further comprising:
a detector comprising:
a first input end coupled to the first input end of the connecting module;
a second input end coupled to the second input end of the connecting module; and
an output end, for outputting an enabling signal when the first input end and the second input end of the connecting module are coupled to the corresponding output ends of the host device; and
a switch comprising:
a first end, coupled to the first input end and the second input end of the connecting module;
a second end, coupled to the output end of the connecting module; and
a control end, coupled to the output end of the detector for receiving the enabling signal;
wherein when the control end of the switch receives the enabling signal, the switch is turned on for the first end of the switch to couple to the second end of the switch.

6. The connecting module of claim 1, wherein:
the first input end of the connecting module is for receiving both data and power from the first output end of the host device;
the second input end of the connecting module is for receiving power from the second output end of the host device; and
the output end of the connecting module is for outputting the power supplied by both the first output end and the second output end of the host device to the external storage device, and outputs the data received from the first output end to the external storage device.

7. An external storage module, comprising:
a connecting module, comprising an output end and a plurality of input ends for coupling to corresponding output ends of a host device; and
an external storage device, coupled to the output end of the connecting module, wherein the external storage device comprises storage means, and the storage means receives power from the host device when at least two input ends of the plurality of input ends of the connecting module are coupled to the corresponding output ends of the host device.

8. The external storage module of claim 7, wherein the external storage device further comprises:
a detector, for detecting whether the plurality of input ends of the connecting module are coupled to the corresponding output ends of the host device, comprising:
an input end coupled to the output end of the connecting module; and
an output end, for outputting an enabling signal when the plurality of input ends of the connecting module are coupled to the corresponding output ends of the host device; and
a switch, comprising:
a first end, coupled to the output end of the connecting module;
a second end, coupled to the storage means of the external storage device; and
a control end, coupled to the output end of the detector for receiving the enabling signal from the output end of the detector;
wherein when the control end of the switch receives the enabling signal, the first end of the switch is coupled to the second end of the switch.

9. The external storage module of claim 7, wherein the connecting module is a Y cable, and the Y cable comprises two input ends.

10. The external storage module of claim 7, wherein the storage means comprises a hard drive.

11. A method for coupling output ends of a host device to an external storage device, the method comprising:
coupling at least one input end of a connecting module to at least one output end of the host device;
coupling an output end of the connecting module to the external storage device;
detecting whether a predetermined number of input ends of the connecting module are coupled to a corresponding number of output ends of the host device; and
when the predetermined number of the input ends of the connecting module are coupled to the corresponding number of the output ends of the host device, outputting power provided by the host device to the external storage device via the connecting module.

12. The method of claim 11, wherein when all input ends of the connecting module are coupled to the host device, the external storage device receives power from the host device via the connecting module.

13. The method of claim 11, wherein when at least one of the input ends of the connecting module is coupled to the host device, the connecting module is powered by the host device.

14. The method of claim 11, wherein the predetermined number of input ends comprises at least two input ends.
